(19) United States
(12) Patent Application Publication
(10) Pub. No.: US 2015/0373301 A1
(43) Pub. Date: Dec. 24, 2015

(54) INPUT FILE TRANSFORMER

(71) Applicant: THOMSON LICENSING, Issy-Les-Moulineaux (FR)

(72) Inventors: Paul JACOBS, Long Beach, CA (US); Dylan S. ROGERS, Dallas, TX (US); Christopher YANG, South Pasadena, CA (US); Morgan HOLLY, Los Angeles, CA (US)

(73) Assignee: THOMSON LICENSING, Issy-Le-Moulineaux (FR)

(21) Appl. No.: 14/653,062

(22) PCT Filed: Aug. 13, 2013
(86) PCT No.: PCT/US2013/054686

§ 371 Date: Jun. 17, 2015

Related U.S. Application Data
(60) Provisional application No. 61/748,947, filed on Jan. 4, 2013.

(51) Int. Cl. H04N 7/01; H04N 21/4402; H04N 21/2343

(52) U.S. Cl. CPC H04N 7/012; H04N 21/234309; H04N 21/440218

(57) ABSTRACT

A method for processing an input file containing frames of video commences by first creating a source file from the input file based on how the frames of video are compressed. Thereafter, a log file is generated for the source file, the log file having information for the frames of video in the source file. The source file then undergoes processing to yield a mezzanine file in accordance with the log file information.

### CROSS-REFERENCE TO RELATED APPLICATIONS

This application claims priority under 35 U.S.C. 119(e) to U.S. Provisional Patent Application Ser. No. 61/748,947, filed Jan. 4, 2013, the teachings of which are incorporated herein.

### TECHNICAL FIELD

This invention relates to a technique for transforming files of video frames from one format to another.

### BACKGROUND ART

The vast majority of content today now exists in electronic (digital) form, including content originally captured on film or other non-digital media. Many automated systems, which handle content in electronic form, require formatting of the content in a particular manner. Often, the incoming content received by such automated systems exists in an inappropriate format for processing. Thus, conversion of the content to a more appropriate format becomes necessary. While various mechanisms exist for re-formatting content, most lack the ability to undertake the necessary re-formatting automatically and to take into account ancillary information, such as sub-titles and multiple audio files.

### BRIEF SUMMARY OF THE PRESENT PRINCIPLES

Briefly, in accordance with a preferred embodiment of the present principles, a method for processing an input file containing frames of video commences by first creating a source file from the input file based on how the frames of video are compressed. Thereafter, a log file is generated for the source file, the log file having information for the frames of video in the source file. The source file then undergoes processing to yield a mezzanine file in accordance with the log file information.

### BRIEF DESCRIPTION OF THE DRAWINGS

FIG. 1 depicts a block schematic diagram of a system in accordance with the present principles for analyzing a given source file to determine the type of video in the file, and determine the best method for returning a progressive mezzanine file for use in one or more automated systems that require input files of a known start state;

FIGS. 2-5 collectively depict a process executed by the system of FIG. 1 to analyze a given source file to determine the type of video in the file, and determine the best method for returning a progressive mezzanine file in accordance with a preferred embodiment of the present principles;

FIG. 6 depicts a chart listing different possible parameters associated with a given input file; and

FIG. 7 depicts a chart showing the expected behavior of the file transformation process of FIGS. 2-5 for target frame rates and transcoding properties.

### DETAILED DESCRIPTION

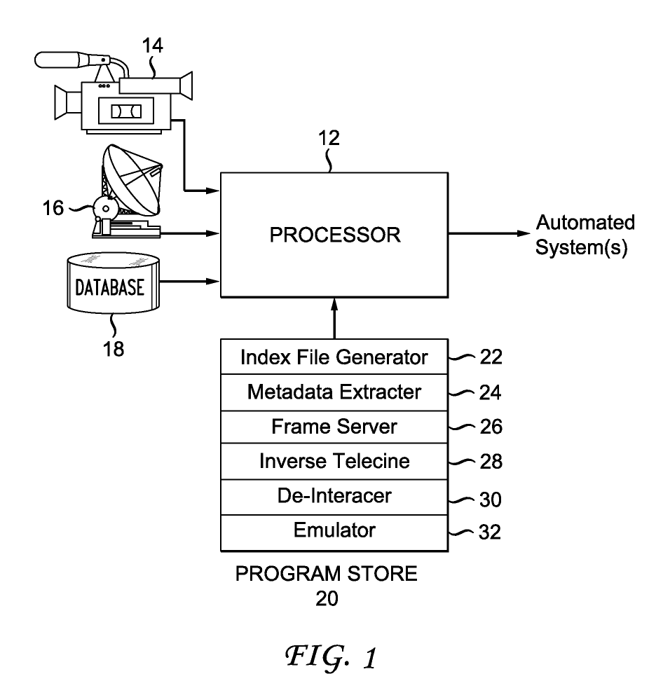

FIG. 1 depicts a block schematic diagram of a system 10 for transforming an input file having frames of video into a mezzanine file suitable for one or more automated systems (not shown). As described in greater detail below, the input file could have compressed video frames, and/or interlaced video frames making the input file unsuited for such automated system(s). The system 10 of the present principles advantageously transforms such input files automatically into a mezzanine file having the desired format.

The system 10 includes a processor 12, typically, but not necessarily, in the form of a personal computer that includes: a display, one or more input devices (e.g., a mouse and keyboard) as well one or more internal and/or external data storage mechanisms, all not shown. Further, the processor 12 can include one or more network interface mechanisms (not shown) typically in the form of circuit cards for enabling the processor to interface to an external network.

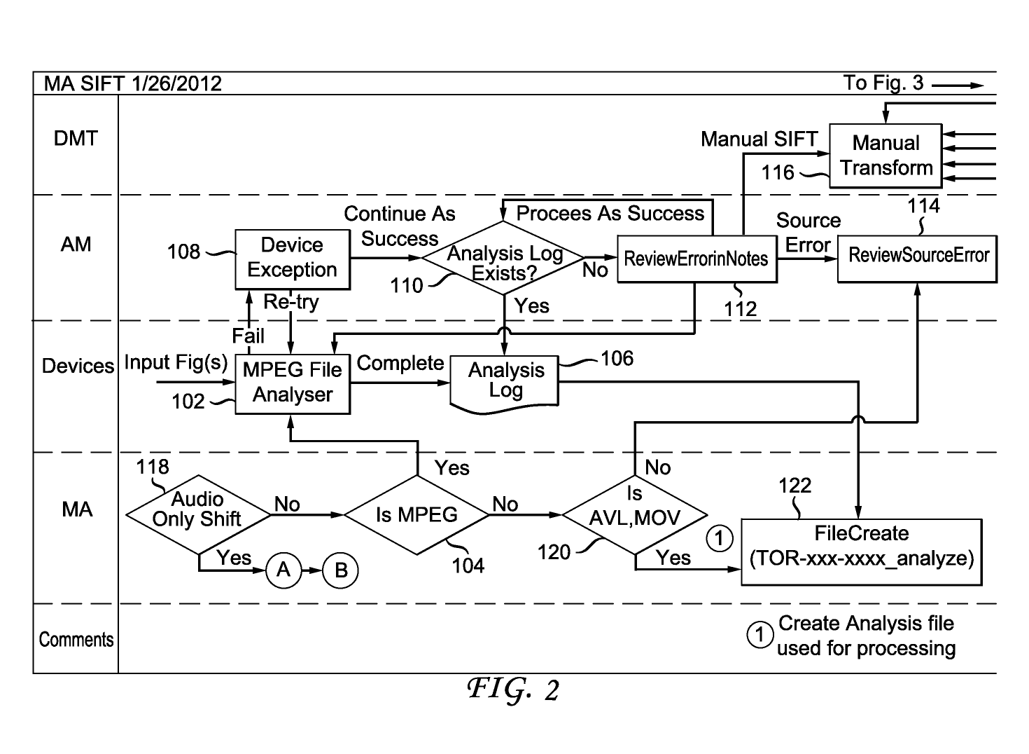

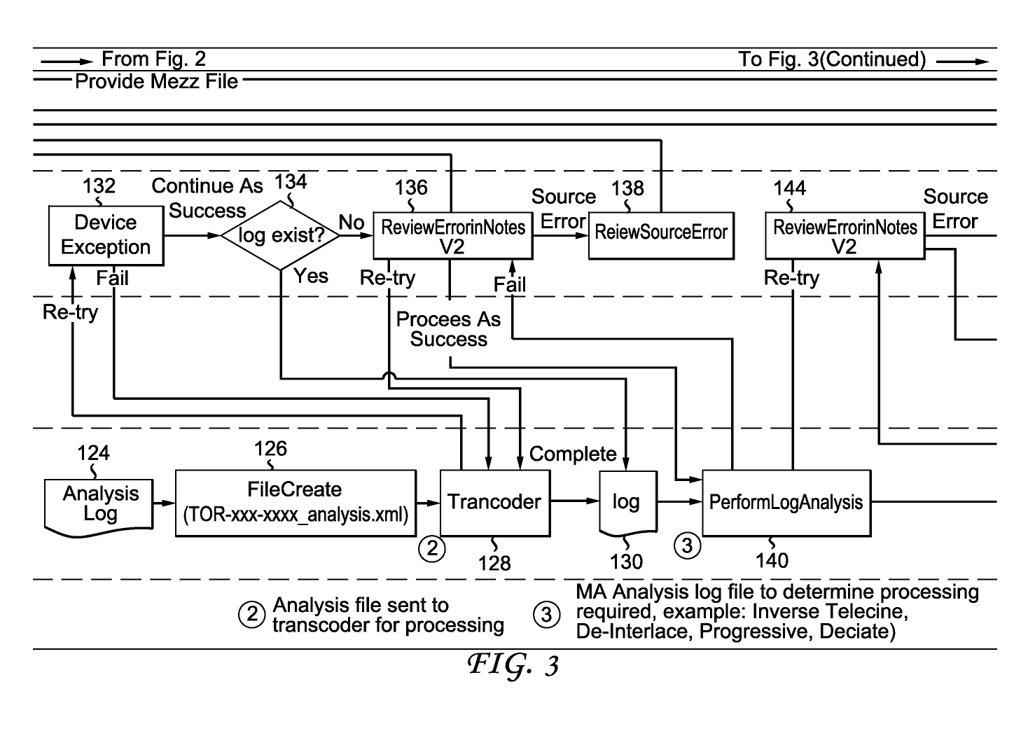

The processor 12 has the capability of receiving input files having video frames from a variety of sources. For example, and without limitation, the processor 12 can receive input files with video frames from a television camera 14, a satellite receiver 16, and/or a database 18. To transform an input file received from any of the sources 14, 16 and 18, the processor 12 executes one or more programs to perform a succession of steps described in greater detail with respect to the flow-charts of FIGS. 2-5, to analyze the input file with respect to the manner in which the video frames have been compressed (if at all) and whether the frames are interlaced. The processor 12 processes the input file to create a source file in accordance with the video frame compression and then de-interlaces the video frames (if interlaced). Thereafter, the processor 12 generates a log file having information for the frames of video. Using the log file, the processor 12 transforms the processed source file into a mezzanine file in accordance with the log file information.

To enable transformation of the input to a mezzanine file, the processor 12 typically makes use of one or more sub-programs stored in a program store 20. For purposes of illustration, FIG. 1 depicts the program store 20 external to the processor 12 although in practice, the program store 20 would typically reside internal to the processor on a storage device (not shown) such as a hard disk drive or the like. The program 20 typically includes an index file generator 22, such as the well-known DGIndex program, for creating an index file for video frames compressed using the MPEG compression standard. The program store 20 also includes a metadata extractor 24, such as the well-known program MetaInfo, for extracting metadata associated with the video frames within the input file. Additionally, the program store 20 includes a frame server 26, in the form of the AVISynth program, for enabling the processor 12 to process individual video frames. Further, the program store 20 includes an inverse Telecine program for 28 performing an inverse telecine process on the input files and a de-interlacer 30 for de-interlacing the input file if needed. In practice, the AVISynth program includes two plug-ins; Telecide and TDeint for handing the inverse telecine processes and for de-interlaces video frames, respectively.

Lastly, the program store includes an emulator 32, typically the program Cygwin, for emulation of Microsoft Windows®.

During processing of input video frames described using the sub-programs 22-32 as discussed hereinafter with respect to process depicted in FIGS. 2-5, the processor 12 makes use of the following templates:
16×16_AVI_Template.xml—This template is used when creating an_analysis.log file from an AVS script.
PJPEG_Destination.xml—This template is used when creating the final mezzanine file.
Decimate.avs—This template is used in connection decimating a source file having a frame rate of 29.97 frames per second (progressive) where every fourth frame is repeated. Decimating will eliminate the repeated frame to create a 23.976 progressive video file.
DeInterlace.avs—This template is used in connection with de-interlacing an input file having a frame rate of 25 or 29.97 frames per second (interlaced). De-Interlacing the input file will create a progressive image without changing the frame rate.
IVTC.avs—the source file is 29.97 interlaced with a telecine pattern. Using an IVTC process will remove the telecine pattern ending with a progressive 23.976 video
Progressive.avs—the source file can be any frame rate that is already a progressive image. No additional processing needs to be applied.
   During the processing of the frames, several files are created to communicate with one or more of the sub-programs 22-32 in the manner described in greater detail with respect to FIGS. 2-5. The following list describes each of the files:

fileProperties.txt—This file holds some basic technical metadata about the original source file listed as the MediaUNC in the control file. This file is created in the first script, SIFT_Step1.sh. The information in this file comprises a pipe delimited list of the following properties: Width, Original Width, Height, Aspect Ratio, and Frame Rate.

Jobname.avs—This file comprises the AVS file that will be used as the source video file when creating the final mezzanine file. The contents of this file will be determined by the analysis of the source file's interlacing patterns. This is the file that will create the progressive output.

outfile.d2v—This file is only present if the source file is an MPEG source. This is the index file created by the sub-program 22 (e.g., the DGIndex process).

analysis.log—This is the log file created by the frame server 26 (AVISynth) that indicates if the frame is interlaced and if the frame is considered moving.

_analyze.avs—This is the AVS file that is used as a source to create the _analysis.log file described hereinafter.

analyze_queue.xml—This is the job queued to by the processor 12 using the _analyze.avs file as the source input.

analyze.avi—This is a 16×16 pixel AVI file created by processor 12 when it parses the source video to create the log file.

AVS evaluate.xml—This is a Carbon API xml that will evaluate the Jobname.avs file so that it can be properly used as a source.

AVS_evaluate_reply.xml—This is the response from the Carbon API when the AVS_evaluate.xml is submitted. It will contain the proper XML structure to be used for the AVS file when creating the _queue.xml file.

_queue.xml—This is the job submitted to processor 12 that will create the final mezzanine file.

_Source evaluate.xml—This is a Carbon API xml that will evaluate the alternate file to be used as the alternate audio source.

_Source_evaluate_reply.xml—This is the response from the Carbon API when the _Source_evaluate.xml is submitted. It will contain the proper XML structure to be used for the alternate audio source when creating the _queue.xml file.

The individual sub-programs 22-32 described about could exist as separate programs. Typically, some or all of the sub-programs or their functionality exist on one or more commercially available programs, such as for example the Rhozet™ Workflow System software by Harmonic, Inc. San Jose, Calif. In practice, the processor 12 will make use of the Rhozet™ Workflow System software to perform the various functions described hereinafter.

FIGS. 2-5, when viewed collectively, depict in flow chart form the sequence of steps executed by the processor 12 of FIG. 1 to transform an input file into a mezzanine file in accordance with the present principles. Referring to FIG. 2, the process begins with receipt with an input file at the processor 12 of FIG. 1 which acts at this time as an MPEG file analyzer, depicted as block 102 in FIG. 2, to undertake an analysis of the input file during step 104 to determine whether the video frames in the input file have been compressed using the MPEG compression standard. If the input file has comprises an MPEG-2, then the processor 12 makes use of the sub-program 22 (e.g., DGIndex) to create a file (d2v) used as the source used by the frame server sub-program 26 (e.g., the AVISynth script). When the input file comprises an MPEG file, the processor 12 creates analysis log 106. Typically, the Rhozet Workflow System software executed by the processor 12 uses the AVIS files to generate the analysis log 106.

Note that the processor 12 of FIG. 1 could fail determine whether the input file has video frames compressed using the MPEG compression standard. Under such circumstances, one or more re-tries would occur. Depending on the allowable number of re-try attempts undertaken, the processor 12 of FIG. 1 could decide to create a device exception during step 108 and thereafter determine whether an analysis log exists during step 110. If a log analysis file does exist, then that existing log analysis file becomes the log analysis file 106 of FIG. 2, thereby obviating the need for the processor 12 of FIG. 1 to separately create such a file. If no such log file exists, the processor 12 will review the error notes generated during step 112 after determining no analysis log file exists during step 110. Based on a review of the error notes generated during step 112, the processor 12 could decide to (1) assume success in determining if a log file exists, (2) re-try the analysis, (3) assume successful execution of step 110, (4) review possible source errors during 114, or (5) proceed with manual source file transformation via a manual routine during step 116. The manual routine executed during step 116 will undertake execution of the Index File Generator sub-program 22 (“DG Index”) stored in the program store 20 to generate an output file (outfile.dv.2) for use in generating the mezzanine file.

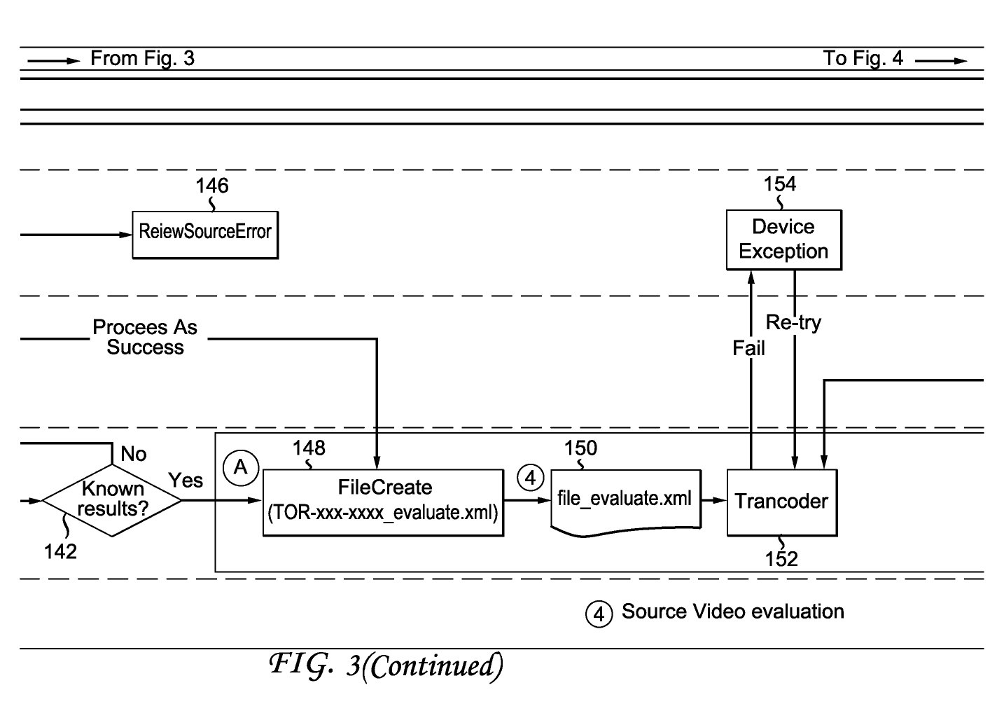

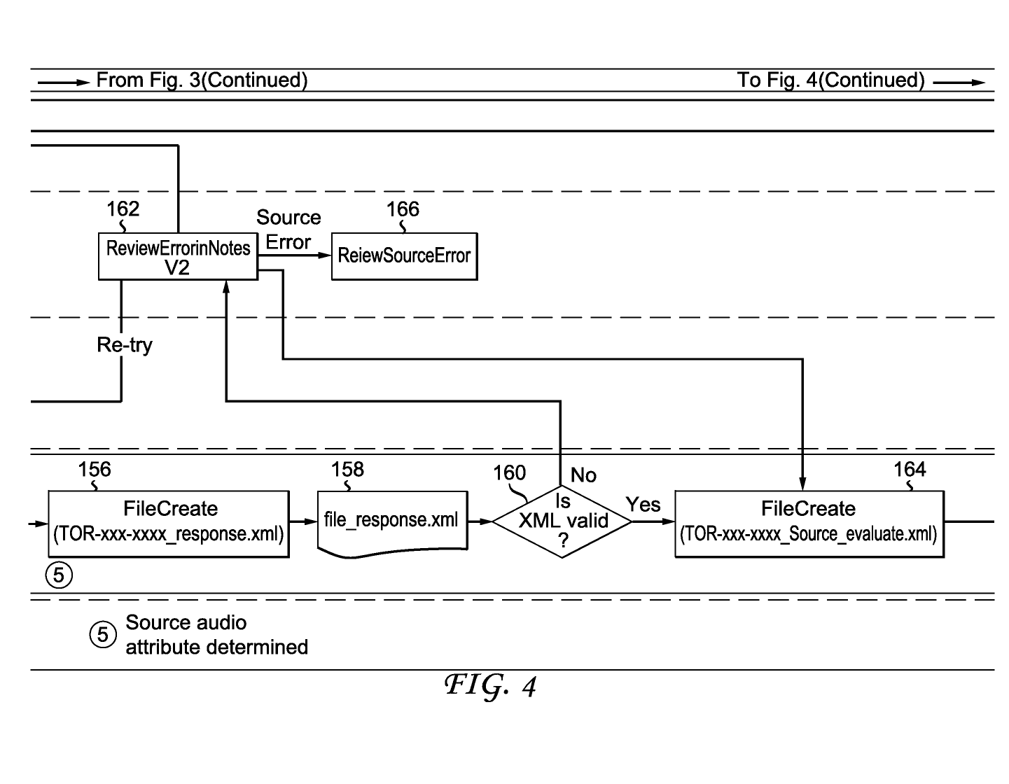

During step 104, the processor 12 of FIG. 1 could determine that the received input file does not have video frames compressed using the MPEG video compression standard. Under such circumstances, a check occurs during step 118 whether the received input file has any video frames at all. For example, the input file could be an audio-only whereupon the process follows branch “A” to step 148 of FIG. 3 (described hereinafter). An input file that has video frames, but not MPEG-compressed video frames, will undergo analysis during step 120 to determine whether the input file has an AVI or MOV format. If so, then the processor 12 of FIG. 1 creates an analysis file during step 122 of FIG. 2 bearing the indicia “TOR-xxx-xxxx_analyze.” The analysis file 122 undergoes further processing during step 124 to yield the file “Analyze_file.xml.

Using the file generated during step 124, the processor 12 of FIG. 1 creates a file (TOR-xxx-xxxx_analyze.xml) during step 126. That XML file undergoes transcoding during step 128. Assuming successful transcoding during step 128, the processor 12 of FIG. 1 then generates a log file during step having information about each video frame in the file during step 130. To this end, the processor 12 can make use of the metadata extractor sub-program 24 and the Frame Server sub-program 26 (AVISynth script), both stored in the program store 20 of FIG. 1 to generate the log file using the Rhozet Workflow System software.

The log file created by processor 12 constitutes a simple text file with two columns of true/false values. The first column indicates if the frame is interlaced. The second column indicates states frame movement. Analysis of input video occurs by parsing groups of five frames each. Examining five video frames at a time enables proper sorting of such a group of frames into one of the following the four categories: video-based, film-based, progressive, or 4th frame repeat.

In order to avoid false positives that can skew the results, the second column value for each of the 5 frames in the group must have a true value. A sequence frames that does not move can skew the results towards a progressive categorization since the image remains static and there would be no combing artifacts in an interlaced file. If all five frames do not move, then the processor 12 will ignore the entire group. This rule has an exception. If the group has 4 trues and 1 false (four moving frames), the processor 12 will consider the sequence with the 4th frame deemed a repeat.

If all five frames move, then the processor 12 will count the number of true values in the first column. If five true values exist, the processor 12 will deem this group of frames as being video based. If true values exist, then the processor 12 will deem this group of frames progressive. If two true values exist, then the processor 12 will deem this group of frames film-based. If one, three or four true values exist, then the group of frames lacks reliability and could skew the results. After the processor 12 processes the entire log file, one of the four categories should have a higher group of frames associated with it. Each one of the categories has an appropriate AVS script that will correctly process the source file.

The processor 12 of FIG. 1 could fail to properly transcode the file during step 128 of FIG. 3. Under such circumstances, the processor 12 of FIG. 1 would re-try to transcode the file a certain number of times. Assuming that the processor 12 has exhausted the allowable number of re-tries, then, the processor could decide to create a device exception during step 132 and thereafter determine whether a log file exists during step 134. If a log analysis file does exist, then that existing log file becomes the log file, thereby obviating the need for the processor 12 of FIG. 1 to separately create such a file. If no such log file exists, the processor 12 will review the error notes generated during step 136 after determining no analysis log file exists during step 134. Based on a review of the error notes generated during 136 of FIG. 2, the processor 12 of FIG. 1 could decide to (1) assume success in determining if a log file exists, (2) re-try the analysis, (3) assume successful execution of step 134, (4) review possible source errors during step 138, or (5) proceed with manual source file transformation during step 116 of FIG. 2.

Assuming successful establishment of the log file, the processor 12 of FIG. 1 analyzes the log file containing information about the frames of video to determine the processing required to establish the desired mezzanine file during step 140. Typically, one or more of four processing operations can occur, Decimate, De-Interlace, Inverse Telecine, or Progressive scan. For example, the video frames could be interlaced or have repeated frames or both which could render the frames unsuited for subsequent automated processing. To that end, the processor 12 of FIG. 1 will make use one or both of the Inverse Telecine sub-program 28 and the De-Interlacer sub-program 30 stored in the Program Store 20 of FIG. 1.

In event of a need to perform a de-interlacing operation, the processor 12 of FIG. 1 will make use the Delnterlace.avs template to create an AVS file from the input file. Using the AVS file, the processor 12 will execute the De-interlacer sub-program to accomplish such decimation. Execution of De-interlacer sub-program software using a 16×16_AVI_Template.xml template will produce a small AVI file in the HuffYUV codec that is 16 pixels by 16 pixels in size. This file constitutes a dummy file ultimately discarded after use. By using this template in connection with De-interlacer sub-program, the processor 12 can de-interlace the file to obtain progressive frames without changing the frame rate.

In event of the need to remove repeated frames, the processor 12 will typically make use of the template Decimate.avs perform an inverse telecine operation to decimate the file, thereby removing the repeated frames. For example, for an input file having progressive video frames with a frame rate of 29.97, with every fourth frame repeated, decimating this file will eliminate the repeated frame to yield progressive video frames at a rate of 23.976 frames per second.

The input file could have both interlaced and repeated frames. Under such circumstances, the processor 12 would typically make use of the IVTC.avs template using the Rhozet™ Workflow System software. For example, assume an input file having video frames is 29.97 interlaced with a telecine pattern. Using an Inverse TeleCine process, the processor 12 will remove the telecine pattern yielding progressive video frames at a rate of 23.976 frames per second.

The input file could have progressive video frames at a particular frame rate not requiring either inverse telecine processing or de-interlacing or both. Under such circumstances, the processor 12 of FIG. 1 would make use of the Progressive.avs template and not apply any additional processing.

Following step 140, the processor 12 of FIG. 1 checks for known results during step 142 of FIG. 3. In other words, the processor 12 checks whether the analysis performed during step 140 yields an error-free result (“yes”) or an erroneous result (“no”). In the event of an erroneous result, the processor 12 executes step 144 to review the error notes (if any) generated following manual file transformation initiated during step 116 of FIG. 1. Based on a review of the error notes during step 144 of FIG. 3, the processor 12 of FIG. 1 could decide to (1) assume success performing the analysis during step 140 notwithstanding the “no” result during step 142 and proceed to step 148 as described hereinafter, (2) re-execute step 140, or execute step 146 to review identified errors, or (3) proceed with manual file transformation during step 116 of FIG. 1.

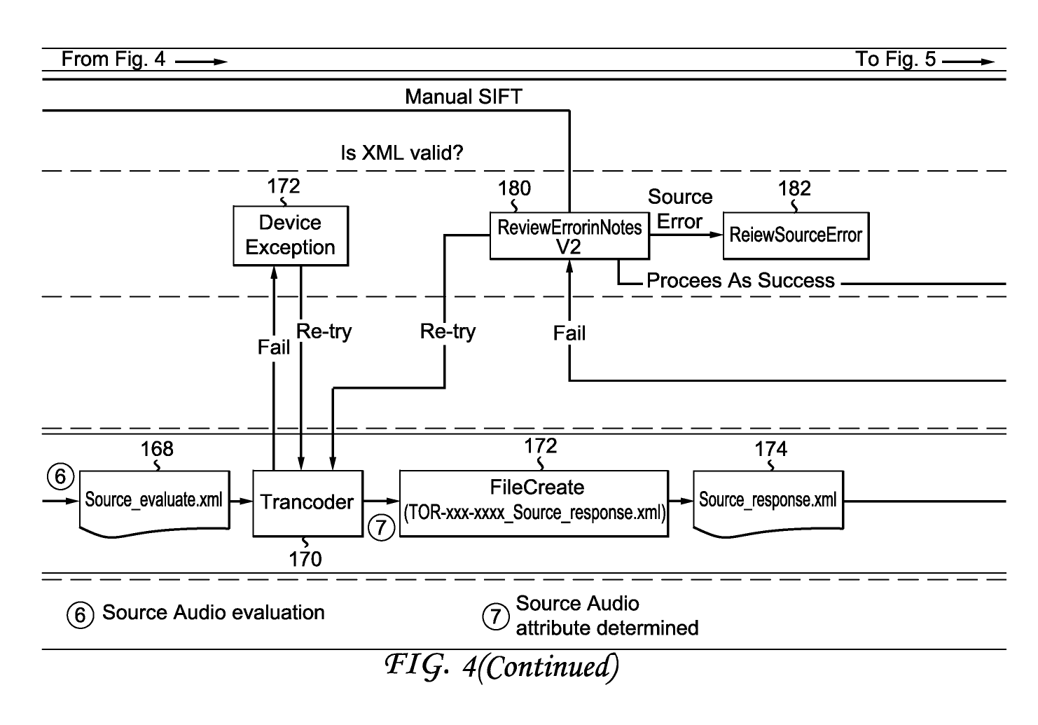

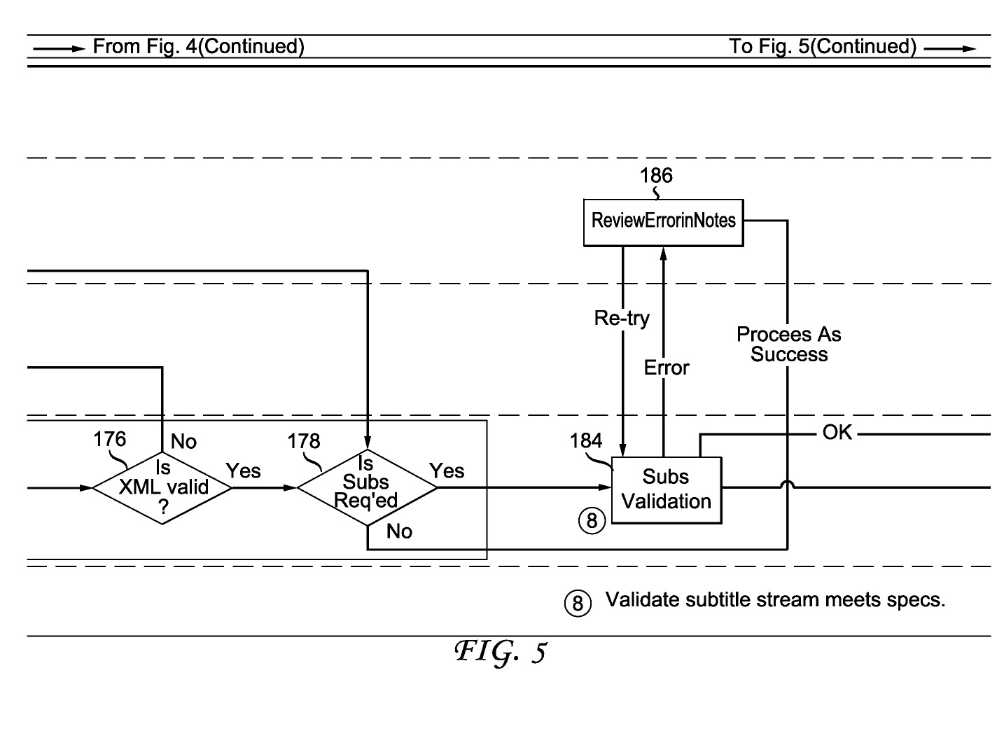

Upon execution of step 148 of FIG. 3, the processor 12 commences evaluation of the source video by first creating an XML file “TOR-xxx-xxxx_evaluate.xml” which undergoes subsequent processing during step 150 to yield a file designated as file_evaluate.xml for transcoding during step 152. If the transcoding fails during step 152, the step 154 of FIG. 3 undergoes execution to determine whether a device exception exists, warranting a re-try of the transcoding. Assuming successful transcoding, the processor 12 will generate the file XML file “TOR-xxx-xxxx_response.xml” during step 156 of FIG. 4. The file TOR-xxx-xxxx_response.xml generated during step 156 undergoes subsequent processing during step 158 to generate the file “file_respomse.xml” as part of the evaluation by the processor 12 of the video attributes in the source file. During step 160, the processor 12 checks whether the file generated step 158 constitutes a valid XML file. Assuming a valid XML file during step 158, the processor 12 of FIG. 1 will then generate the file “TOR-xxx-xxxx_Source_evaluate.xml” during step 164. If the processor 12 does not find the XML file valid during step 160, then the processor 12 will review the error notes generated during step 162. Based on a review of the error notes generated during step 162 of FIG. 3, the processor 12 of FIG. 1 could decide to (1) assume a valid XML file, (2) re-try the transcoding during step 152, (3) review possible source errors during step 166 or (4) proceed with manual source file transformation via the manual routine 116 of FIG. 2.

Following step 164, the file “TOR-xxx-xxxx_Source_evaluate.xml” undergoes subsequent processing during step 168 to yield a file designated as “Source_evaluate.xml” as in connection with the evaluation of the audio in the source file. The file “Source_evaluate.xml” undergoes transcoding during step 170. If the transcoding fails during step 170, then step 172 of FIG. 4 undergoes execution to determine whether a device exception exists, warranting a re-try of the transcoding step 170. Assuming successful transcoding during step 170, the processor 12 then generates the file XML file “TOR-xxx-xxxx_Sourceresponse.xml” during step 172 of FIG. 4. The file TOR-xxx-xxxx_Sourceresponse.xml generated during step 172 undergoes subsequent processing during step 174 to generate the file “Source_respomse.xml” in connection with determination of the audio attributes in the source file. During step 176, the processor 12 checks whether the file generated step 174 constitutes a valid XML file. Assuming a valid XML file during step 174, the processor 12 of FIG. 1 will proceed to step 178. If the processor 12 does not find the XML file valid during step 176, then the processor 12 will review the error notes generated during step 180 of FIG. 4. Based on a review of the error notes generated during step 180 of FIG. 4, the processor 12 of FIG. 1 could decide to (1) assume a valid XML file and proceed to step 178, (2) re-try the transcoding during step 170, (3) review possible source errors during step 182 or (4) proceed with manual source file transformation via the manual routine 116 of FIG. 2.

Upon execution of step 178 of FIG. 4, the processor 12 of FIG. 1 determines whether the source file includes subtitles. If so, then the processor 12 executes step 184 to validate the subtitles. Assuming successful validation during step 184, the processor 12 proceeds to step 185 to extract and normalize the audio by establishing audio parameter, and populating the parameters in the file. If the processor 12 cannot validate the sub-titles during step 184, then the processor 12 proceeds to step 186 to review error notes generated during the validation of the subtitles. Based on a review of the error notes generated during step 186 of FIG. 4, the processor 12 of FIG. 1 could decide to: (1) assume a successful subtitle validation and proceed to step 185, (2) re-try the validating the subtitles during step 184, or (3) review possible source errors during step 186.

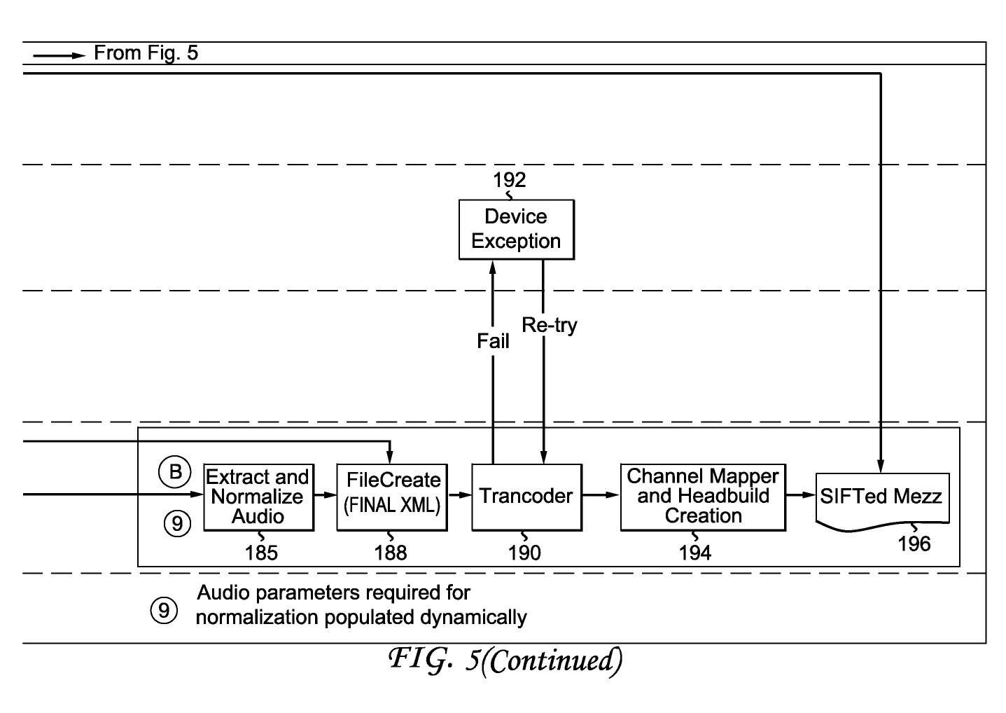

Following extraction and normalization of the audio during step 185 of FIG. 5, the processor 12 creates a final output file (FINAL_XML) during step 188. The final output file then undergoes transcoding during step 190. If the transcoding fails during step 190, then step 192 of FIG. 5 undergoes execution to determine whether a device exception exists, warranting a re-try of the transcoding step 190. Assuming successful transcoding during step 190 of FIG. 5, the processor 12 of FIG. 1 then executes step 194 to undertake channel mapping and file header building as part of the process normalize the audio parameters for population in the file. Lastly, the processor 12 undertakes step 196 to transform the file into a mezzanine file have the desired format. In the illustrated embodiment, the processor 12 makes use of the Rhozet™ Workflow System software to create the final mezzanine file. Assuming the processor 12 has successfully generated the mezzanine file, then processor will update a text file (MA.txt file) accompanying the mezzanine file with the word SUCCESS as the last line in the file. Otherwise, if the processor 12 cannot successfully generate the mezzanine file without errors, the processor 12 will update the _MA.txt file by noting an error via a brief message in the last line in the file. If the processor 12 cannot generate the desired mezzanine after a retry using the Rhozet™ Workflow System software, then this should go to a DMT for manual file transformation using something other than the Rhozet™ Workflow System software.

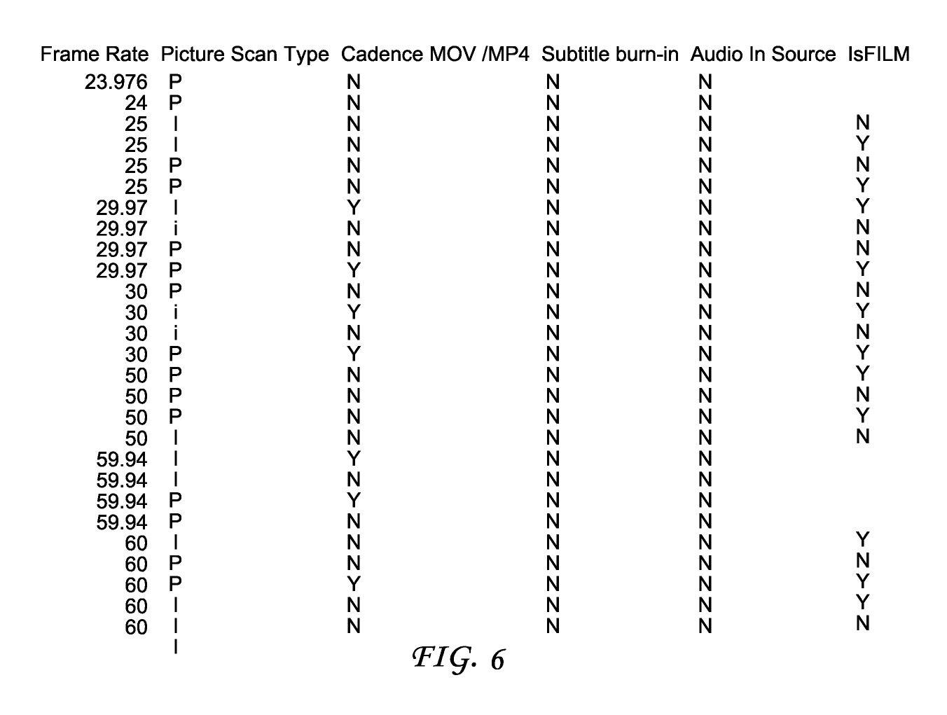

FIG. 6 depicts a chart listing different possible parameters associated with a given source file. As indicated in FIG. 6, a given source file can possess one of many possible frame rates and picture scan types ranging from 23.976 frames per second (progressive) to 60 frames per second (interlaced). Further, a given source file can have MOV/MP4 cadence or not. Typically, for the possible difference frame rates and picture types depicted in FIG. 6, none of the source files has burned-in subtitles or incorporated audio, but source files could exist with these features indicated by a “yes” in the appropriate column. Further, the source file could comprise an IsFILM file.

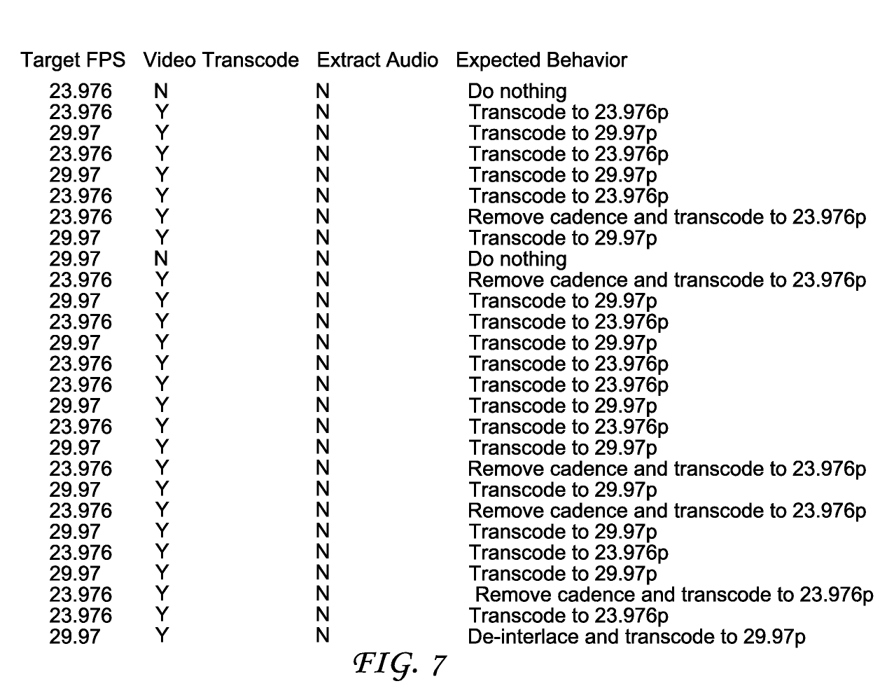

FIG. 7 depicts a chart showing the expected behavior of the file transformation process of FIGS. 2-5 for target frame rates and transcoding properties. Thus, for a target frame rate of 23.976 frames per second not transcoded, and with no audio extraction, the file transformation process of the present principles will take no action. In contrast, consider a target frame rate of 29.97 frames per second with transcoding. For such a target frame rate, the file transformation process of the present principles will de-interlace and transcode the video frames to 29.97 frames per second progressive.

The foregoing describes a technique for transforming files of video frames from one format to another.

1. A method for processing an input file containing frames of video, comprising the steps of:
creating a source file from the input file based on how the frames of video are compressed;
generating a log file for the source file, the log file having information for the frames of video in the source file;
processing the source file to yield into a mezzanine file in accordance with the log file information.

2. The method according to claim 1 wherein the log file contains information indicative of a need to perform at least one of the following operations: Decimate, De-Interlace, Inverse Telecine, and Progressive scan.

3. The method according to claim 1 wherein the processing of the source file includes decimating the source file when the log file indicates a need to perform the Decimate operation.

4. The method according to claim 1 wherein the processing of the source file includes de-interlacing the source file when the log file indicates a need to perform the De-Interlace operation.

5. The method according to claim 1 wherein the processing of the source file includes decimating the source file to remove repeated frames when the log file indicates a need to perform the Inverse Telecine operation.

6. The method according to claim 1 wherein the processing step includes transcoding the source file.

7. The method according to claim 1 wherein the processing step further includes extracting and normalizing audio associated with the video frames.

8. The method according to claim 1 wherein the step of processing the source file occurs automatically.

9. The method according to claim 1 wherein the step of processing the source file occurs manually.

10. Apparatus for processing an input file containing frames of video, comprising:
a processor for (a) creating a source file from the input file based on how the frames of video are compressed, (b) generating a log file for the source file, the log file having information for the frames of video in the source file; and (c) processing the source file to yield into a mezzanine file in accordance with the log file information.

11. The apparatus according to claim 10 wherein the log file contains information indicative of a need to perform at least one of the following operations: Decimate, De-Interlace, Inverse Telecine, and Progressive scan.

12. The apparatus according to claim 10 wherein the processor processes the source file by decimating the source file when the log file indicates a need to perform the Decimate operation.

13. The apparatus according to claim 10 wherein the processor processes the source file by de-interlacing the source file when the log file indicates a need to perform the De-Interlace operation.

14. The apparatus according to claim 10 wherein the processor processes the source file by decimating the source file to remove repeated frames when the log file indicates a need to perform the Inverse Telecine operation.

15. The apparatus according to claim 10 wherein the apparatus further processes the source file by transcoding the source file.

16. The apparatus according to claim 10 wherein the apparatus further processes the source file by extracting and normalizing audio associated with the video frames.
